(19) United States
(12) Patent Application Publication
(10) Pub. No.: US 2009/0058193 A1
(43) Pub. Date: Mar. 5, 2009

(54) Wall switch for lighting load management system for lighting systems having multiple power circuits

(75) Inventors: Drew A. Reid, Brentwood, TN (US); William O. Stottlemyer, Mount Juliet, TN (US)

Correspondence Address: SCHNEIDER ELECTRIC / SQUARE D COMPANY;LEGAL DEPT. - I.P. GROUP (NP), 1415 S. ROSELLE ROAD, PALATINE, IL, 60067, US

(73) Assignee: Square D Company

(21) Appl. No.: 11/897,744

(22) Filed: Aug. 31, 2007

(51) Int. Cl. H01H 35/00

(52) U.S. Cl. 307/116

(57) ABSTRACT

A wall switch is provided for an automatic lighting control system for a space equipped with multiple lamps for illuminating the space and multiple power circuits for supplying power to different groups of said lamps. The wall switch includes at least one sensor detecting conditions or events that indicate that increased illumination of the space by the lamps is needed or decreased illumination of the space by the lamps is allowable. Normal control of the electric lighting is thus automatic to a large degree. But, at least two manually operable switches are coupled to the microcontroller to provide the microcontroller with ON and OFF command signals for at least two of the lamp groups powered by different power circuits. A separate status indicator light for each of the switches is controlled by the wall switch and provides an indication of whether the lamp group associated with each manual switch is currently ON or OFF as a safety and economy feature.

### FIELD OF THE INVENTION

The present invention relates to a wall switch for use with a lighting load management system for lighting systems having multiple power circuits and that automatically turn lights ON and/or OFF in response to control signals from sensors that detect whether a space is occupied or not occupied.

### BACKGROUND OF THE INVENTION

Automatic shut-off lighting controls are used to save electrical energy, and are often required by legislated energy codes. Today's control devices have multiple control outputs which are used to operate multiple lighting circuits in a particular area. The advantage of having multiple circuits feeding an area is that multiple levels of light can be achieved by selecting the number of circuits that are ON simultaneously. This multiple-level ability is also required by some energy codes so that lower levels of artificial illumination can be provided in an occupied area.

The type and arrangement of light fixtures is a factor in the application of multiple-circuit lighting controls. For example, alternate rows of lights can be fed from different circuits such that when only a portion of the lights are turned ON or OFF, the level of illumination is relatively even. This method can also be used with the light fixtures wired in a checker board pattern. Another common variation is the use of light fixtures with multiple ballasts, or specialty ballasts that can be fed from multiple circuits. This approach allows control of individual lamps within the fixture. For example, a light fixture with four lamps and two ballasts can provide illumination levels of 0%, 50%, or 100%. Another example is a light fixture with three lamps and two ballasts that can provide illumination levels of 0%, 33%, 66%, or 100%, achievable by having one ballast to provide energy to one lamp and the other to two lamps.

Multiple lighting levels can be controlled manually by a wall switch, automatically by a sensor, or both. An occupancy sensor can be used to automatically turn lights ON when a person enters an area and then turn lights OFF when all occupants have left an area. A light level sensor is often used in conjunction with this approach to prevent one or more light circuits from turning ON in response to occupancy. Natural light from windows, skylights or other sources adds to the illumination of the area. When a lighting control device determines that sufficient natural light reduces the need for artificial light, it will respond by allowing only a minimum level of artificial lighting to be automatically turned ON.

The multiple-circuit approach is also useful in situations where no natural light is available. An occupancy sensor will automatically turn ON lights when a person enters an area. To save energy, only a minimum level of light will be turned ON in response to this event. If a task in the area requires greater illumination, the occupant can manually turn ON additional light levels. The lighting control device will turn OFF all light circuits when the area is unoccupied. Only the minimum level will be restored on subsequent entries to the area.

### SUMMARY OF THE INVENTION

The use of multiple power circuits in combination with an automatic lighting control management system can give rise to situations where it is difficult for a user to intervene with the desired manual control. For example, a user may be in an illuminated space where it is difficult to determine visually which of two or more banks of lights may be currently operating. As a controller of power to the multiple light banks, the wall switch will have multiple manual switches for the multiple power circuits, and thus a user desiring more light might inadvertently turn OFF the only circuit that is currently ON, thus plunging the occupied space into darkness.

In one embodiment, a wall switch is provided for a lighting control system for a space equipped with multiple lamps for illuminating the space and multiple power circuits for supplying power to different groups of said lamps. The wall switch includes a form of automatic illumination control such as at least one sensor detecting conditions or events that indicate that increased illumination of the space by the lamps is needed, or conversely, that decreased illumination of the space by the lamps is allowable. For example, such a sensor may be a so-called “occupancy sensor” indicating human activity, or lack thereof, in the illuminated space. The sensor of the present invention produces output signals in response to the detection of such conditions or events, and a microcontroller receives the output signals from the sensor and produces control signals in response to the detection of conditions or events that indicate that increased illumination of the space by the lamps is needed. The wall switch includes at least two relay drivers responsive to the control signals for supplying power separately to the relay power circuits in response to the control signals.

At least two manually operable switches are coupled to the microcontroller to provide the microcontroller with ON and OFF command signals for at least two of the lamp groups powered by different power circuits, and a separate status indicator light associated with each of the switches provides an indication of whether the lamp group associated with each switch is currently ON or OFF. In one implementation, each of the status indicator lights is automatically illuminated by signal from the microcontroller when its associated lamp group is ON thereby giving a direct visual indication of which power circuit and lamp group has been activated by the automatic illumination control. By indicating the status of power control, the occupant is not likely to accidentally turn off the powered lights. Thus, wear on the lights and disruption of proper illumination can be minimized.

One particular embodiment includes a location-indicating light associated with each of the manually operated switches. The location-indicating lights may be the status-indicating lights energized intermittently to produce a flashing light. To reduce power consumption, the location-indicating lights may be energized only when needed. For example, the location-indicating lights may be energized in response to at least one of (a) the detection of motion in the space being monitored and (b) the sensing of an ambient light level below a preselected threshold in that space, and de-energized in response to (a) the expiration of prescribed time interval following the energization of those lights or (b) the energization of at least one of the lamp groups.

### BRIEF DESCRIPTION OF THE DRAWINGS

The invention may best be understood by reference to the following description taken in conjunction with the accompanying drawings, in which:

FIG. 1 is a front elevation of a wall plate control unit used with one embodiment of a lighting load management system embodying the invention.

FIG. 2 is a side elevation of the wall plate control unit of FIG. 1.

FIG. 3 is a top plan view of the wall plate control unit of FIG. 1.

FIG. 4 is the same front elevation shown in FIG. 1 with the front covers of the two pushbuttons removed to reveal the underlying structures.

FIG. 5 is a side elevation of the wall plate control unit of FIG. 4.

FIG. 6 is a top plan view of the wall plate control unit of FIG. 4.

FIG. 7 is a front elevation of a modified wall plate control unit used with one embodiment of a lighting load management system embodying the invention.

FIG. 8 is a diagrammatic illustration of one embodiment of a lighting load management system for a lighting system having two or more electrical power circuits for a space equipped with multiple lamps.

FIG. 9 is an electrical schematic diagram for one specific implementation of a portion of the lighting load management system of FIG. 8.

FIG. 10 is a flow chart of one embodiment of a routine that can be executed by the microcontroller in the system of FIGS. 8 and 9.

FIG. 11 is a flow chart of another embodiment of another routine that can be executed by the microcontroller in the system of FIGS. 8 and 9.

### DETAILED DESCRIPTION OF THE ILLUSTRATED EMBODIMENTS

Although the invention will be described in connection with certain preferred embodiments, it will be understood that the invention is not limited to those particular embodiments. On the contrary, the invention is intended to cover all alternatives, modifications, and equivalent arrangements as may be included within the spirit and scope of the invention as defined by the appended claims.

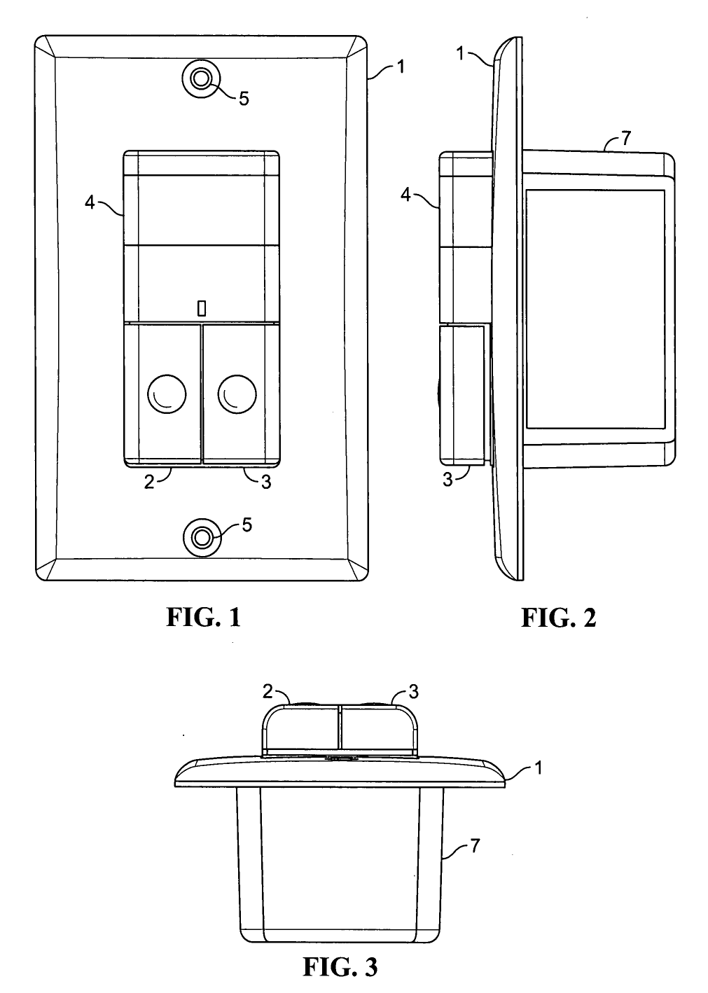

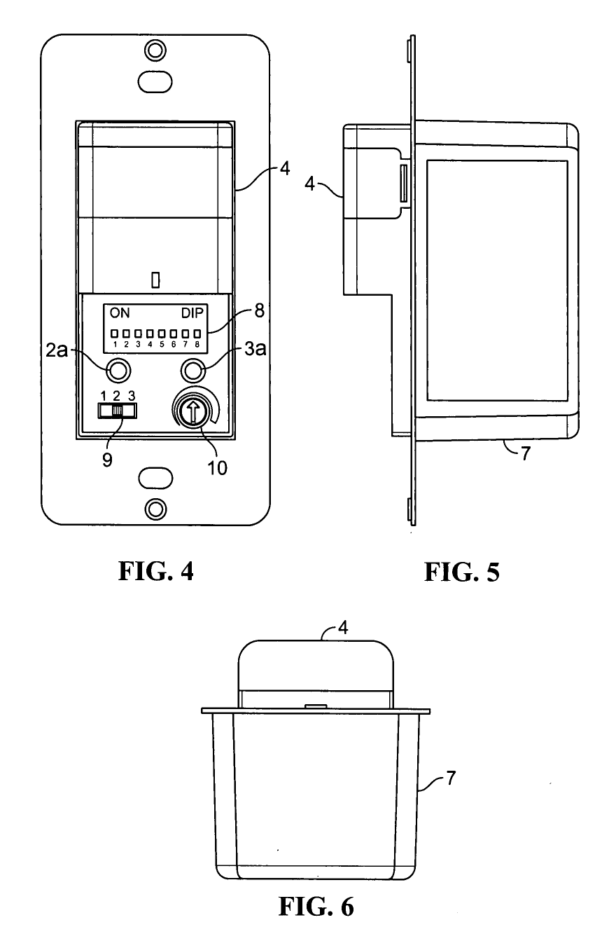

Turning now to the drawings and referring first to FIGS. 1-3, a wall plate 1 surrounds a control unit that includes a pair of pushbuttons 2 and 3 and a transparent cover 4 for the lens of a motion sensor for detecting motion within a space having artificial illumination. The plate 1 forms a pair of holes 5 for receiving a pair of screws to attach the plate 1 to a wall. FIGS. 4-6 show the same control unit shown in FIGS. 1-3 with the wall plate 1 and the covers of the pushbuttons 2 and 3 removed, revealing the underlying metal frame 6 and control unit 7. As seen most clearly in FIG. 4, the front of the control unit 7 includes a DIP switch 8, the actuators 2a and 3a of the respective pushbuttons 2 and 3, a three-position mode switch 9, and a potentiometer 10 for adjusting the sensitivity of an ambient light sensor.

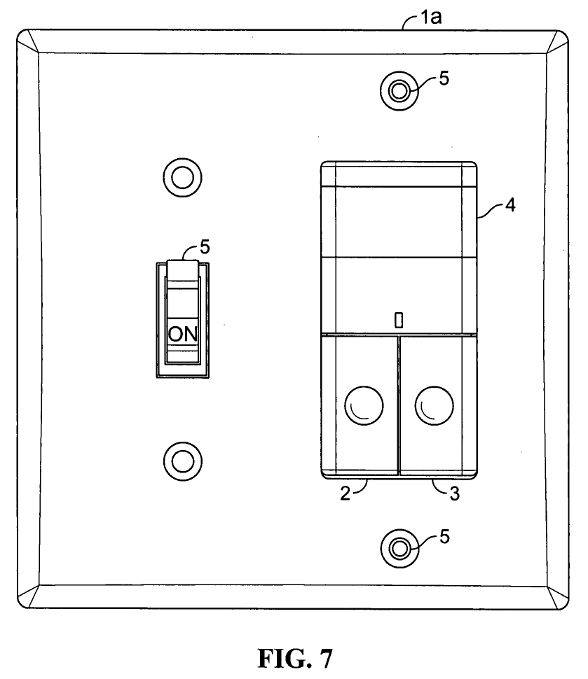

FIG. 7 illustrates a modified wall plate la that accommodates a standard on/off switch S, in addition to the control unit 7.

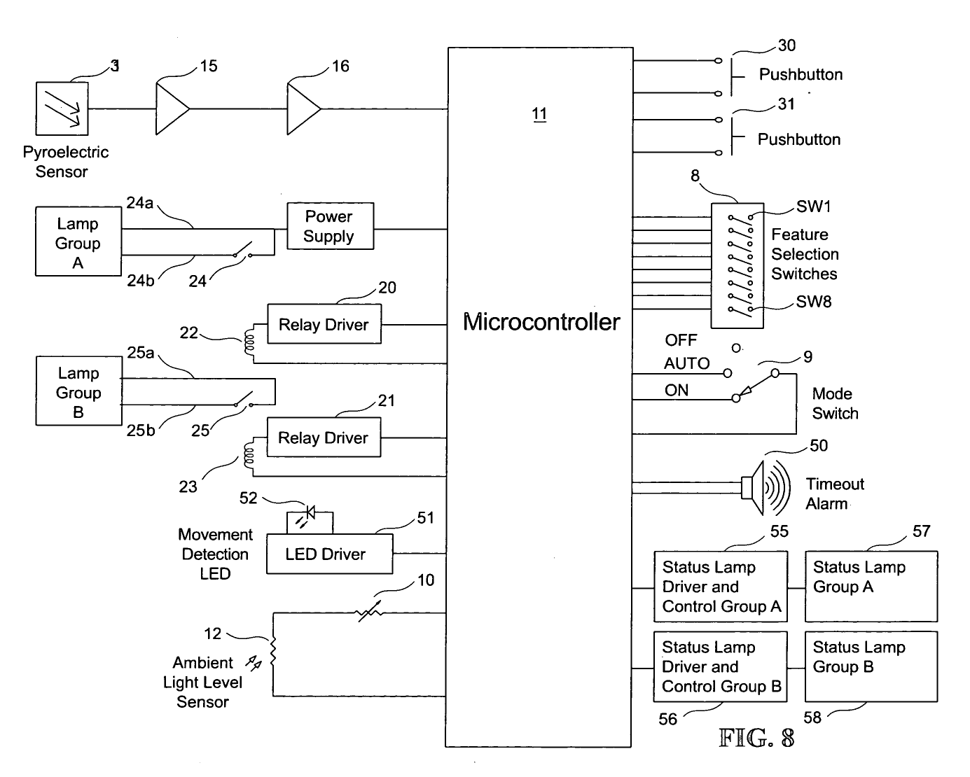

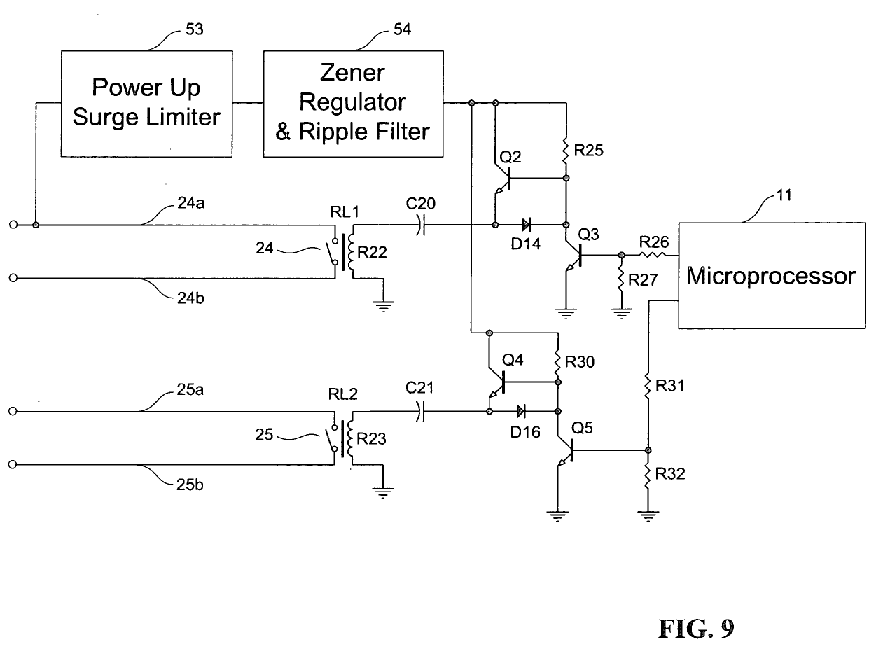

FIG. 8 illustrates the control unit 7 in more detail. A microcontroller (processor) 11 receives input signals from multiple sensors and switches and uses these input signals, along with information that it stores regarding successive energization and de-energization of different lamp groups A and B, to produce output signals that control the supply of power to multiple power circuits that supply power to different groups of lamps for illuminating a common space at different light levels. The microcontroller 11 executes an algorithm that determines which lamp group should be energized or de-energized each time an “initiating event” indicates a need to increase or decrease the artificial illumination of the monitored space.

Specifically, the microcontroller 11 receives input signals from an ambient light sensor 12, such as a conventional cadmium sulfide sensor whose resistance varies in proportion to the intensity of the ambient light, thereby varying the current flow through, and thus the voltage drop across, the; sensor 12; and a motion detector 13, such as a conventional passive infrared (“PIR”) sensor that detects infrared emissions from occupants in the monitored space. The sensitivity of the ambient light sensor 12 can be adjusted by the potentiometer 10. The output signal from the motion detector 13 is passed through a bandpass filter 15 and a low-pass filter 16 to remove spurious signals that do not represent movement of occupants.

Another type of event that can be used to turn selected groups of light ON or OFF is an event that requires an adjustment of the load imposed on a power distribution system. Such load-shedding or load-restoring commands are generated by systems designed to control the rates charged for power consumption under agreements that base the charge on the conditions that exist at the time of consumption, such as the time of day, the overall load on the system, etc.

The microcontroller 11 produces control signals for a pair of relay drivers 20 and 21 that control the energization and de-energization of respective coils 22 and 23 of a pair of latching relays. The coils 22 and 23 control the opening and closing of corresponding relay contacts 24 and 25, which in turn control the energization and de-energization of a pair of power circuits providing power to two lamp groups A and B. Specifically, closing the relay contacts 24 supplies power to lamp group A by connecting lines 24a and 24b, which closes a circuit that includes a conventional power source and lamp group A. Similarly, closing the relay contacts 25 supplies power to lamp group B by connecting lines 25a and 25b, which closes a circuit that includes a conventional power source and lamp group B. Thus, the control signals supplied by the microcontroller 11 to the relay drivers 20 and 21 can control whether either or both of the lamp groups A and B are supplied with power at any given time. It will be understood that additional lamp groups may be accommodated by simply replicating the circuitry associated with lamp group A or B.

As will be described in detail below, the microcontroller 11 can supply control signals to the relay drivers 20 and 21 in response to the execution of an algorithm that utilizes stored information related to the history of energization and de-energization of the two lamp groups A and B. Alternatively, the control signals can be produced in response to the operation of the manual pushbutton-operated (momentary) switches 30 and 31, which act as toggle switches. Thus, if lamp group A is OFF, pressing pushbutton 2 momentarily closes the switch 30 to cause the microcontroller 11 to send the relay driver 20 a control signal that causes the driver to turn ON lamp group A. Pressing the pushbutton 2 again turns OFF lamp group A. Pushbutton 3 and its switch 31 operate in the same manner for controlling lamp group B.

The manually operated mode switch 9 can be set to any of three positions to cause the microcontroller 11 to operate in any of three different modes. The “AUTO” mode causes the microcontroller 11 to send control signals to the relay drivers 20 and 21 in response to the results of an algorithm executed by the microcontroller, as described in detail below. In the “ON” mode, the microcontroller 11 produces control signals that cause both relay contacts 24 and 25 to close and remain closed, so that both lamp groups A and B are energized, regardless of what conditions or events are sensed. In the “OFF” mode, the microcontroller 11 produces control signals that cause both relay contacts 24 and 25 to open and remain open, so that both lamp groups A and B are de-energized, regardless of what conditions or events are sensed. When either the “ON” or “OFF” mode is selected, the states of the relay contacts 24 and 25 cannot be altered by pressing either of the pushbuttons 2 and 3.

The microcontroller 11 also receives inputs from the manually settable DIP switch 8, which in the illustrative example has eight switches SW1-SW8 that can be individually set ON or OFF. The settings of the eight switches SW1-SW8 select the features of the control system for the “AUTO” mode, as follows:

Position

| DIP | Feature | ON | OFF |
|---|---|---|---|
| SW1 | Timeout Value | see table below | see table below |
| SW2 | Timeout Value | see table below | see table below |
| SW3 | Timeout Value | see table below | see table below |
| SW4 | Activation | Automatic ON | Manual ON |
| SW5 | Audible Alert | Enabled | Disabled |
| SW6 | Walk Through | Enabled | Disabled |
| SW7 | Reduced Sensitivity | Enabled | Disabled |
| SW8 | Load Balance | Enabled | Disabled |

The timeout values selectable by the settings of the first three switches SW1-SW3 are as follows:

| Time Delay (Minutes) | SW3 | SW2 | SW1 |
|---|---|---|---|
| (Unused) | OFF | OFF | OFF |
| 2 | OFF | OFF | ON |
| 5 | OFF | ON | OFF |
| 10 | OFF | ON | ON |
| 15 | ON | OFF | OFF |
| 20 | ON | OFF | ON |
| 25 | ON | ON | OFF |
| 30 | ON | ON | ON |

When the switch SW4 is set to the “AUTOMATIC ON” mode position and motion is detected by the occupancy sensor 13, the microcontroller 11 sends a control signal to the relay driver 20 to cause the relay coil 22 to be energized, thereby turning ON the lamp group selected by an algorithm executed by the microcontroller 11, as described in more detail below. At the same time, the microcontroller 11 starts a “delayed-off” timer to measure a fixed time interval (e.g., 5 minutes), and repetitively re-starts the timer if motion is detected during that interval. When motion is not detected during the fixed time interval measured by the “delayed off” timer, the system turns OFF both lamp groups.

With the switch SW set in the “AUTOMATIC ON” position, the pushbutton-operated switches 30 and 31 can toggle their respective lamp groups A and B ON and OFF, regardless of what other features have been selected by the settings of the DIP switch 8. When either lamp group A or B is toggled OFF by its associated pushbutton 2 or 3, the system starts an “intentional off” timer to measure a fixed time interval (e.g., 5 minutes), and is repetitively re-started if motion is detected during that interval. When motion is not detected during the fixed time interval measured by the “intentional off” timer, the system reverts to the “AUTOMATIC ON” operation at the end of that interval. When either lamp group is toggled ON by its associated pushbutton 2 or 3, the system turns off the “intentional off” timer and reverts to the “AUTOMATIC ON” operation. This feature prevents the lights from being turned OFF as long as occupants are still present in the monitored space, even after a pushbutton has been pressed to intentionally turn the lights OFF.

With the switch SW4 is set in the “MANUAL ON” position, the pushbutton-operated switches 30 and 31 must be used to toggle their respective lamp groups A and B ON, regardless of what other features have been selected by the settings of the DIP switch 8. The pushbutton-operated switches 30 and 31 each have a lamp and/or other indicator associated therewith for conveying the power status of their associated lamp groups, as further explained below. The system will not automatically turn ON either lamp group with the switch SW4 in this position. When either lamp group A or B is toggled ON, the system energizes the relay coil associated with that lamp group and also starts the “delayed off” timer. The “delayed off” timer is typically set to measure a fixed time interval (e.g., 5 minutes), and repetitively re-starts each time motion is detected, or either lamp group is toggled ON by one of the pushbuttons 30 and 31, during that interval. This feature prevents the lights from being turned OFF as long as occupants are present in the monitored space, while also ensuring that the lights will be automatically turned OFF within a short time after the space has been vacated.

When motion is not detected during a fixed time interval measured by the “delayed off” timer, the system turns OFF both lamp groups and then reverts to “MANUAL ON” operation. The system also starts a “reactivation” timer that measures a fixed “grace” period (e.g., 15 to 30 seconds). If motion is detected during this “grace” period, any lamp group just turned OFF is turned ON again, and the “delayed off” timer is re-started. If no motion is detected during the “grace” period, both lamp groups remain OFF.

When the “Load Balance” DIP switch SW8 is set to the ON position to enable this feature, successive microcontroller output signals energize the relay coils 22 and 23 alternately, which causes the lamp groups A and B to be energized alternately. An alternative strategy is to have the microcontroller change the “primary” power circuit sequentially on a periodic basis, such as daily, weekly, monthly, etc. For example, the power circuit for lamp group A can be the primary circuit in the first week, the power circuit for lamp group B can be the primary circuit in the second week, and so forth. When the “Load Balance” feature is disabled by setting the DIP switch SW8 to the OFF position, lamp group A is always energized when only one lamp group is needed, and lamp group B is energized only when both lamp groups are needed.

The “Walk-Through” feature, which is enabled by the setting of the DIP switch SW6, operates independently of the setting of the switch SW4. When the “Walk-Through” feature is enabled and both lamp groups are OFF, the system starts a “temporary timeout” timer to initiate a “temporary time-out” period (e.g., two minutes) when movement is first detected or when a lamp group is manually turned ON by one of the pushbuttons 2 or 3. If movement is detected after the first 30 seconds, then the system reverts to the normal timeout period determined by the settings of the switches SW1-SW3. If no movement is detected after the first 30 seconds, then the system continues with the “temporary timeout” value. The “Walk-Through” mode is not active when the system is re-triggered within 30 seconds of an OFF event by the “grace” period timer.

The “Audible Alert” feature, which is selected by the setting of the switch SW5, causes the microcontroller 11 to produce a timeout alarm signal that activates an alarm 50 to alert occupants when the artificial illumination is about to be turned OFF. For example, a single one-second tone may be produced ten seconds prior to turning OFF both lamp groups. If movement is detected during the ten seconds following the one-second tone, two half-second tones may be produced to indicate that occupancy has been detected.

The “Reduced Sensitivity” feature, which is selected by the setting of the switch SW7, reduces the sensitivity of the motion sensor to approximately 60% of the maximum sensitivity by changing the sensitivity of the pyroelectric sensor circuit. Specifically, operating the switch SW7 changes the detection threshold of a comparator circuit by inserting another resistor in parallel with the bottom leg of a voltage divider network that sets the threshold of a double-ended limit detector (window comparator). Whenever an amplified signal from the PIR sensor rises above this threshold, the microcontroller is alerted.

The signal from the ambient light sensor is utilized by the microcontroller 11 whenever the mode switch 9 is set to the “AUTO” position. The ambient light sensor 12 continuously measures the ambient light level, and the setting of the potentiometer 10 sets an ambient-light threshold (e.g., over a range from approximately 0.5 foot-candles to approximately 250 foot-candles). When the ambient light is below the threshold and motion is detected, both lamp groups A and B are turned ON. When the ambient light is above the threshold and motion is detected, only the primary light group (e.g., group A) is turned ON. If the secondary lamp group (e.g., group B) is ON when the ambient light level rises above the threshold while the space is occupied, the secondary lamp group is not turned OFF. If the secondary lamp group (e.g., group B) is OFF when the ambient light level falls below the threshold while the space if occupied, the secondary lamp group is turned ON. Setting the potentiometer to a threshold value at the lower end of the threshold range essentially causes the secondary lamp group to be always turned ON in response to occupancy. If a failure occurs with the ambient light sensor, the system allows the secondary lamp group to turn ON by disabling this feature, i.e., setting the threshold to the upper end of its range.

The microcontroller 11 also produces a movement detection signal that causes an LED driver 51 to momentarily turn ON a movement detection LED 52, each time the microcontroller receives a signal from the PIR sensor 13 indicating that movement within the monitored space has been detected.

To indicate to a user which of the power circuits/lamp groups under automatic control is ON or OFF at any given time, the microcontroller 11 also supplies signals to a pair of status lamp drivers 55 and 56 for a pair of status lamps 57 and 58, respectively. The status lamps 57 and 58 are associated with the respective pushbuttons 30 and 31, to provide a visible indication of the ON or OFF status of the power circuit associated with each pushbutton. For example, if only the status lamp 57 is illuminated then only lamp group A is ON. The user can also see the illuminated status indicator of lamp group B is also off. Thus, the user immediately knows which pushbutton(s), of the multiple pushbuttons arrayed on the wall switch, he can push to turn ON one or both lamp groups, regardless of whether the user can visually identify which group of lamps is currently operating.

The status lamps 57 and 58 may be associated with the respective pushbuttons in a variety of different ways. For example, light pipes can be used to transmit light from the lamps 57 and 58 to transparent or translucent portions of the respective pushbuttons 30 and 31. Alternatively, the lamps 57 and 58 can be mounted directly in, or adjacent to, the respective pushbuttons 30 and 31.

FIG. 9 is a schematic diagram of one implementation of the relay driver circuits 20 and 21 (FIG. 8) that control the energization and de-energization of the lamp groups A and B in response to signals produced by the microcontroller 11. The control signals from the microcontroller 11 are supplied to the bases of respective transistors Q3 and Q5 via voltage dividers formed by resistor pairs R26, R27 and R31, R32 to control the energization and de-energization of respective coils 22 and 23 of relays RL1 and RL2. For example, when the control signal for the relay RL1 goes high, it turns on the transistor Q3, which draws current through a resistor R25 from a power supply derived from the power line 24a via a conventional power-up surge limiter 53 and a conventional zener regulator and ripple filter 54. The base of a transistor Q2 is connected to the junction of the resistor R25 and the collector of the transistor Q3.

As long as the transistor Q3 is off, the transistor Q2 supplies a trickle charge to a capacitor C20, and the contacts 24 of the latching relay RL1 remain open. When the transistor Q3 is turned on by the control signal from the microcontroller 11, the transistor Q2 turns off, and the capacitor C20 discharges through a diode D14 and the transistor Q3. This causes the latching relay to close its contacts 24, which closes the circuit between the power conductors 24a and 24b to supply power to the lamp group A. This circuitry maintains the current levels below 0.5 milliamp to satisfy standards requirements for installations where the ground connection is used for control power.

The latching relay RL2 for lamp group B is controlled in the same manner by an identical relay driver formed by transistors Q5 and Q4, resistor R30, capacitor C21 and diode D16.

In the event of a power interruption, the position of the relay contacts is as follows:

If the switch SW4 is in the “AUTOMATIC ON” position, the relay contacts remain closed for a short time after the power is restored.

If the switch SW4 is in the “MANUAL ON” position and the relay contacts were open prior to the interruption, the contacts remain open.

If the switch SW4 is in the “MANUAL ON” position and the relay contacts were closed prior to the interruption, the system temporarily enters the AUTOMATIC ON mode, allowing the contacts to close.

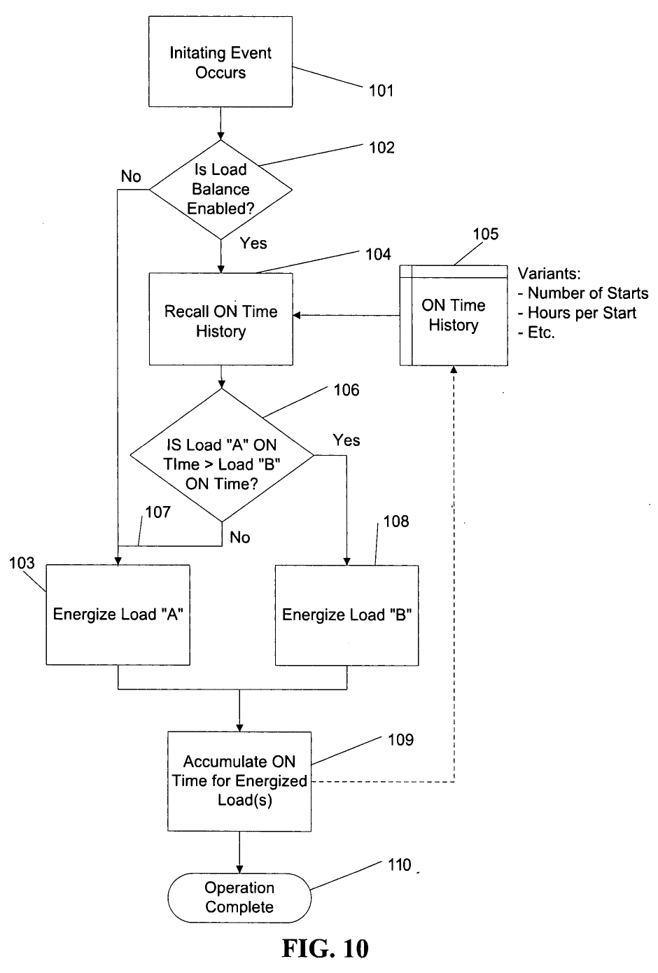

FIG. 10 is a flow chart of an algorithm that can be executed by the microcontroller 11, in response to an initiating event, to select the power circuit(s) to be supplied with power, based on stored information representing which power circuit was energized in response to the previous initiating event. The sub-routine of FIG. 10 is initiated by the detection of an event that indicates that a change in the artificial illumination of the monitored space is needed or allowable, when the DIP switch SW4 is set to the Automatic ON position. Examples of such initiating events are a change in the occupancy status of the space (becoming occupied or unoccupied) as detected by the sensor 13, or a change in the natural (ambient) light level in the space as detected by the sensor 12.

The occurrence of an initiating event is detected at step 101 and causes the sub-routine to proceed to step 102 to determine whether the “load balance” feature has been enabled by the setting of the switch SW8. If the answer at step 102 is negative, the sub-routine proceeds to step 103 to energize relay coil 22 to turn ON the “primary” lamp group A. If the answer at step 102 is affirmative, the routine proceeds to step 104 which retrieves from memory 105 information indicating which lamp group was previously energized.

After the previously energized lamp group has been identified by the information retrieved at step 104, the system proceeds to step 106 to determine whether lamp group A was the previously energized group. If the answer is affirmative, then the lamp group B is energized at step 107. If the answer at step 106 is negative, the lamp group B is energized at step 108. In either case, the routine then proceeds to step 109 to store the identification of the newly energized lamp group in the memory 105. The routine is then exited at step 110.

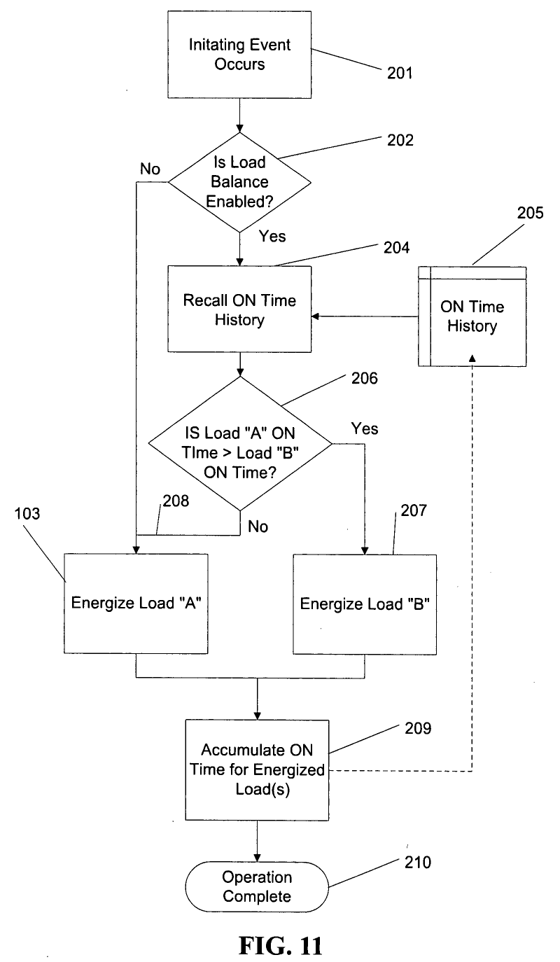

FIG. 11 is a flow chart of an alternative algorithm that can be executed by the microcontroller 11, in response to an initiating event, to select the power circuit(s) to be supplied with power, based on the stored information relating to the history of energization and de-energization of the different power circuits. The sub-routine of FIG. 11 is initiated by the detection of an event that indicates that a change in the artificial illumination of the monitored space is needed or allowable, when the DIP switch SW4 is set to the Automatic ON position. Examples of such initiating events are a change in the occupancy status of the space (becoming occupied or unoccupied) as detected by the sensor 13, or a change in the natural (ambient) light level in the space as detected by the sensor 12.

The occurrence of an initiating event is detected at step 201 and causes the sub-routine to proceed to step 202 to determine whether the “load balance” feature has been enabled by the setting of the switch SW8. If the answer at step 202 is negative, the sub-routine proceeds to step 203 to energize relay coil 22 to turn ON the lamp group A, which is the group of lamps designated as the “primary” group. If the answer at step 202 is affirmative, the routine proceeds to step 204 which retrieves from memory 205 information relating to the history of energization and de-energization of each individual power circuit. In this particular sub-routine, the retrieved information represents the cumulative “ON” time for each of the two lamp groups A and B.

After the stored information has been retrieved at step 204, the system proceeds to step 206 to compare the cumulative “ON” times of the two lamp groups. If the cumulative “ON” time for group A is greater than that of group B, the lamp group B is energized at step 207. If the reverse is true, the system energizes the lamp group B at step 208. In either case, the routine then proceeds to step 209 to resume accumulation of the “ON” time of the selected lamp group and storage of that information in the memory 205. The routine is then exited at step 210. The cumulative “ON” times of the two lamp groups would be reset to zero each time the lamps are replaced.

Instead of accumulating the “ON” time of each circuit, the system could store a number representing the difference between the “ON” times of the two circuits. A positive number could indicate a longer cumulative “ON” time for lamp group A, and a negative number a longer cumulative “ON” time for lamp group B. The algorithm would then simply check the polarity of the stored number and treat the lamp group not represented by that polarity as the “primary” group (i.e., to be energized first).

In the embodiments described above, the sensors and the power circuitry are all contained in the same housing, which is sufficiently compact to be made as an integral part of a wall unit. It should be understood, however, that the power circuitry can be packaged separately from the sensors in a separate housing that can be mounted in a location remote from the wall unit containing the sensors.

Instead of, or in addition to, controlling the energization and de-energization of multiple power circuits, the energization and de-energization of multiple lamps may be controlled by the use of controllable fluorescent ballasts. Such ballasts are used in digitally addressable lighting systems which all or some of the lamps have controllable ballasts coupled to network that can be used to communicate with each individual ballast. The ballast is able to respond to such communications to turn a lamp ON or OFF or to adjust the “dim level” of the lamp. Thus, the control signals produced by the microprocessor in the system described above can be used to control individual lamps, rather than power circuits, to achieve a substantially uniform lamp “wear rate” (e.g., cumulative illumination time and/or number of power initiation events).

When a monitored space is occupied but little or no motion occurs, the lamps in all groups can be automatically turned OFF. Audible tones have been used as alerts that lights are about to be turned OFF, but audible alerts can be masked by other sounds or headphones or hearing protection. Blinking the lights has also been used as an alert, but certain types of lamps cannot be blinked (e.g., HID lamps that require 5-10 minute cool-down periods). With the multiple power circuits used in the system of the present invention, the occupant(s) can be alerted that the lamps are about to be turned OFF, by turning the multiple circuits OFF sequentially rather than simultaneously. When the first circuit is turned OFF, the occupant(s) have time to re-start the control system to keep one or more of the power circuits ON, e.g., an occupant can move to re-start the “delayed off” timer, or one of the pushbuttons 2 and 3 can be pressed.

The status-indicating lamps 57 and 58 may also be used as location indicators, or separate location-indicating lamps may be used in conjunction with the status-indicating lamps. In the following description, the term “location-indicating lamp” shall be understood to include either a combined status- and location-indicating lamp or a separate location-indicating lamp. If a separate location-indicating lamp is used, it should be located in or adjacent to the switch whose location is being identified when that lamp is energized.

It is important to minimize power consumption by the location-indicating lamps, especially when the lamp groups are OFF. Safety regulations typically require that any current drawn by a wall switch that is OFF must be less than 0.5 ma. when the wall switch is not connected to a neutral line. Reducing power consumption also prolongs lamp life. One way to reduce power consumption by the location-indicating lamps is to use neon lamps or LED's.

Another way to limit the power consumption by the location-indicating lamps is to limit their ON time, such as by energizing them intermittently (flashing) rather than continuously. When the status-indicating lamps are also used as location indicators, flashing of the lamps may also serve to distinguish an indication of location from an indication of status.

The ON time of the location-indicating lamps can also be limited is by energizing them only when needed, such as by (1) turning the location-indicating lamps ON only when motion is detected by the motion sensor 13, and (2) automatically turning the lamps OFF after a prescribed time interval or when at least one of the lamp groups is energized, whichever occurs first. For example, in the embodiment described above, when the switch SW4 is set to the “MANUAL ON” position and both lamp groups A and B are OFF, the location-indicating lamps 57 and 58 can remain OFF until motion is detected. The motion detection circuitry remains active at all times, thus allowing the detection of an occupant entering the monitored space. The detection of motion initiates flashing of the location-indicating lamps 57 and 58 to provide an illuminated indication of the location of the manual switches when a user enters the monitored space. The initiation of flashing of the location-indicating lamps is virtually instantaneous, and thus no delay is noticeable to the occupant entering the monitored space. That is, there is no need for the entering occupant to wait for the location-indicating indicator lamps to be illuminated. Power consumption by the location-indicating lamps 57 and 58 is reduced because the location-indicating lamps remain OFF until motion is detected.

Flashing of the location-indicating lamps 57 and 58 is terminated by de-energizing the location-indicating lamps when at least one of the lamp groups A or B is turned ON, or upon expiration of a short time period which allows sufficient time for a lamp group to be turned ON manually. If only one of the lamp groups is turned ON, the location-indicating lamp 57 or 58 for that group is then illuminated continuously, as a status indicator, and flashing of the other location-indicating lamp is terminated because the switch location will be clearly visible in the illumination provided by the lamp group that has been turned ON.

The ambient light sensor 12 can also be used to limit the ON time of the location-indicating lamps by turning ON the lamps only when the ambient light level is below a preselected threshold, i.e., when the ambient light is dim enough that it is useful to have the location-indicating lamps 57, 58 illuminated, to assist an occupant entering a dark space to locate the wall switch. When the ambient light level is above the preselected threshold, the ambient light by itself is sufficient to enable an occupant to locate the switch. The ambient-light-level control may be used by itself, or in combination with motion detection so that the location-indicating lamps are energized only when motion is detected while the ambient light level is below the preselected threshold.

If desired, the system may allow the user to select whether energization of the location-indicating lamps is controlled by motion detection alone, by the ambient light level alone, or by a combination of the two. Such user selectability can be implemented by a hardware such as a three-position switch, or by software or firmware run on the microcontroller so that the selection can be made via keyboard, mouse, touchscreen, etc.

The same features described above in connection with the status-indicating lamps, such as the various timers, may be used to further reduce the power consumption of the location-indicating lamps.

The status-indicating lamps can be used to provide indications of the status of conditions other than whether different lamp groups are ON or OFF. For example, a status indicator lamp can be flashed to indicate that the associated lamp group is about to be turned OFF, so that an occupant has time to exit the illuminated space or to take the action required to keep that lamp group ON. As described above, an audible warning may be generated to alert occupants that a lamp group illuminating a space will be turned OFF following a short time-out period. However, a visual warning in the form of a flashing status indicator light, either alone or in combination with the audible warning, can be useful to hearing-impaired occupants, and can also identify the source of the warning to occupants who are not familiar with the time-out audible warning system. Different flashing rates may be used when the same status indicator lights are used to indicate the status of multiple conditions, or as both location indicators and status indicators for multiple conditions.

While particular embodiments and applications of the present invention have been illustrated and described, it is to be understood that the invention is not limited to the precise construction and compositions disclosed herein and that various modifications, changes, and variations may be apparent from the foregoing descriptions without departing from the spirit and scope of the invention as defined in the appended claims.

1. A wall switch for a lighting control system for a space equipped with multiple lamps for illuminating the space and multiple power circuits for supplying power to different groups of said lamps, said wall switch comprising
at least one sensor detecting conditions or events that indicate that increased illumination of said space by said lamps is needed or decreased illumination of said space by said lamps is allowable, said sensor producing output signals in response to the detection of such conditions or events,
a microcontroller receiving said output signals from said sensor and producing control signals in response to the detection of conditions or events that indicate that increased illumination of said space by said lamps is needed,
at least two drivers responsive to said control signals for supplying power separately to said relay power circuits in response to said control signals,
at least two manually operable switches coupled to said microcontroller to provide said microcontroller with ON and OFF command signals for at least two of said lamp groups powered by different power circuits, and
a separate status indicator light associated with each of said manually operable switches for providing an indication of whether the lamp group associated with each switch is currently ON or OFF.

2. The wall switch of claim 1 in which each of said separate status indicator lights is controlled by the microcontroller.

3. The wall switch of claim 1 in which each of said status indicator lights is illuminated when its associated lamp group is ON.

4. The wall switch of claim 1 in which each of said manually operable switches includes a pushbutton and an associated switch that opens and closes in response to successive depressing movements of said pushbutton.

5. The wall switch of claim 2 in which said status indicator lights illuminate at least portions of the associated pushbuttons.

6. The wall switch of claim 1 in which each of said status indicator lights is a neon lamp or an LED.

7. The wall switch of claim 1 in which said status indicator lights also indicate the status of a condition other than whether the lamp group associated with each switch is currently ON or OFF.

8. The wall switch of claim 7 in which each of said status indicator lights indicates that the associated lamp group is about to be de-energized.

9. The wall switch of claim 1 which includes a location-indicating light associated with each of said manually operable switches.

10. The wall switch of claim 9 in which said location-indicating light is said status indicator light energized intermittently to produce a flashing light.

11. The wall switch of claim 9 in which said location-indicating light is energized in response to at least one of a detection of motion in said space and a sensing of an ambient light level below a preselected threshold in said space.

12. The wall switch of claim 9 in which said location-indicating light is de-energized in response to an expiration of a prescribed time interval following the energization of said location-indicating light or an energization of at least one of said lamp groups or both.

13. The wall switch of claim 9 in which said location-indicating light is a neon lamp or an LED.

14. The wall switch of claim 9 in which each of said location-indicating lights is controlled by said microcontroller.
